(19) United States
(12) Patent Application Publication
(10) Pub. No.: US 2014/0030945 A1
(43) Pub. Date: Jan. 30, 2014

(54) COMPOSITE SHEET AND SUBSTRATE FOR DISPLAY DEVICE INCLUDING THE SAME

(71) Applicants: Kyu Ha CHUNG, Uiwang-si (KR); Sung Kook KIM, Uiwang-si (KR); Young Kwon KIM, Uiwang-si (KR)

(72) Inventors: Kyu Ha CHUNG, Uiwang-si (KR); Sung Kook KIM, Uiwang-si (KR); Young Kwon KIM, Uiwang-si (KR)

(21) Appl. No.: 14/041,190

(22) Filed: Sep. 30, 2013

Related U.S. Application Data
(63) Continuation of application No. PCT/KR2011/009786, filed on Dec. 19, 2011.

(30) Foreign Application Priority Data
Apr. 1, 2011 (KR) 10-2011-0030387

(51) Int. Cl. C08K 3/40

(52) U.S. Cl. CPC C08K 3/40
USPC 442/1; 428/446; 428/698; 428/702; 442/180; 524/588

(57) ABSTRACT

A composite sheet and a substrate for a display device including the same, the composite sheet including a matrix, and a reinforcing material impregnated within the matrix, wherein a ratio of an elastic modulus at 25° C. of the matrix to an elastic modulus at 25° C. of the reinforcing material is 1×10⁻² or less.

### CROSS-REFERENCE TO RELATED APPLICATION

This application is a continuation of pending International Application No. PCT/KR2011/009786, entitled “Composite Sheet and Substrate For Display Device Using the Same,” which was filed on Dec. 19, 2011, the entire contents of which are hereby incorporated by reference.

Korean Patent Application No. 10-2011-0030387, filed on Apr. 1, 2011, in the Korean Intellectual Property Office, and entitled: “Composite Sheet and Substrate For Display Device Using the Same,” is incorporated by reference herein in its entirety.

### BACKGROUND

1. Field

Embodiments relate to a composite sheet and a substrate for a display device including the same.

2. Description of the Related Art

Glass having excellent heat resistance and transparency and a low coefficient of linear expansion may be used in substrates for liquid crystal displays (LCDs) or organic electroluminescent (EL) displays, color filter substrates, solar cell substrates, or the like. Substrate materials for displays should have small size, slimness, lightweight, impact resistance, and flexibility. Thus, plastic materials may also be used as a substitute for a glass substrate.

### SUMMARY

Embodiments are directed to a composite sheet and a substrate for a display device including the same

The embodiments may be realized by providing a composite sheet including a matrix, and a reinforcing material impregnated within the matrix, wherein a ratio of an elastic modulus at 25° C. of the matrix to an elastic modulus at 25° C. of the reinforcing material is 1×10⁻² or less.

The ratio of the elastic modulus at 25° C. of the matrix to the elastic modulus at 25° C. of the reinforcing material may be in a range of 1×10⁻⁷ to 1×10⁻².

The elastic modulus at 25° C. of the matrix may be 1×10⁵ dyne/cm² to 1×10⁹ dyne/cm².

The matrix may include at least one selected from the group of silicone rubber, styrene-butadiene rubber, butadiene rubber, isoprene rubber, chloroprene, neoprene rubber, ethylene-propylene-diene terpolymer, styrene-ethylene-butylene-styrene block copolymer, styrene-ethylene-propylene-styrene block copolymer, acrylonitrile-butadiene rubber, hydrogenated nitrile rubber, fluorinated rubber, plasticized polyvinyl chloride, and combinations thereof.

The reinforcing material may include at least one selected from the group of glass fiber, glass fiber cloth, glass fabric, non-woven glass cloth, glass mesh, glass beads, glass powder, glass flakes, silica particles, colloidal silica, and combinations thereof.

The reinforcing material may include glass fiber cloth, glass fabric, non-woven glass cloth, or combinations thereof.

The reinforcing material may be present in the composite sheet in an amount of 5 to 95 vol %.

The composite sheet may further include a coating layer on at least one surface of the matrix, the coating layer including at least one selected from the group of silicon nitride, silicon oxide, silicon carbide, aluminum nitride, ITO, and IZO.

The embodiments may also be realized by providing a substrate for a display device including the composite sheet according to an embodiment.

The substrate may have a coefficient of thermal expansion less than or equal to 20 ppm/° C.

### BRIEF DESCRIPTION OF DRAWINGS

Features will be apparent to those of skill in the art by describing in detail exemplary embodiments with reference to the attached drawings in which:

FIG. 1 illustrates a sectional view of a composite sheet in accordance with an embodiment; and

FIG. 2 illustrates a sectional view of a composite sheet in accordance with another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

An embodiment provides a composite sheet that includes a matrix and a reinforcing material impregnated within the matrix. A ratio of elastic modulus (E1) at 25° C. of the matrix to elastic modulus (E2) at 25° C. of the reinforcing material may be 1×10⁻² or less (e.g., E1/E2≦1×10⁻²). In an implementation, the ratio of elastic modulus at 25° C. of the matrix to the ratio of elastic modulus at 25° C. of the reinforcing material may be in a range of 1×10⁻⁷ to 1×10⁻², e.g., 1×10⁻⁶ to 5×10⁻⁴. Within this range, the composite sheet may exhibit excellent flexibility and rigidity, and may have a very small coefficient of thermal expansion.

The matrix may have an elastic modulus (E1) at 25° C. of 1×10⁵ to 1×10⁹ dyne/cm². In an implementation, the matrix may have an elastic modulus (E1) at 25° C. of 5×10⁵ to 5×10⁸ dyne/cm², e.g., 5×10⁵ to 5×10⁷ dyne/cm². Within this range, the composite sheet may exhibit excellent flexibility and rigidity, and may have a small coefficient of thermal expansion.

The matrix may have a glass transition temperature of, e.g., −150° C. to 30° C. In an implementation, the matrix may have a glass transition temperature of −130° C. to 20° C., e.g., −130° C. to 10° C. Within this range, the composite sheet may exhibit excellent flexibility and rigidity, and may have a small coefficient of thermal expansion.

The matrix may be composed of or may include a rubber material. For example, the matrix may be composed of or may include silicone rubber, styrene-butadiene rubber (SBR), butadiene rubber, isoprene rubber, chloroprene, neoprene rubber, ethylene-propylene-diene terpolymers, styrene-ethylene-butylene-styrene (SEBS) block copolymers, styrene-ethylene-propylene-styrene (SEPS) block copolymers, acrylonitrile-butadiene rubber (NBR), hydrogenated nitrile rubber (HNBR), fluorinated rubber, or the like. In an implementation, the matrix may be composed of or may include a silicone resin having a glass transition temperature less than or equal to room temperature, or a resin component such as plasticized polyvinyl chloride (PVC) to which a plasticizer is added to ensure flexibility. The materials may be used alone or in combination of two or more thereof. For example, silicone rubber may be used as the matrix of the composite sheet.

The silicone rubber may be organopolysiloxane having an average degree of polymerization of 5 to 2,000. Examples of the organopolysiloxane may include polydimethylsiloxane, polymethylphenylsiloxane, polyalkylarylsiloxane, polyalkylalkylsiloxane, and the like. Each of the materials may have a three-dimensional network structure at a molecular level. In an implementation, the network structure of the silicone rubber may include a single cross-linking point in 5 to 500 R₂SiO units. In an implementation, organopolysiloxane having a viscosity of 5 to 500,000 Cst may be used as the silicone rubber. Within this range, the composite sheet may exhibit excellent flexibility and rigidity, and may have a small coefficient of thermal expansion. In an implementation, the silicone rubber may have a viscosity of 50 to 120,000 Cst, e.g., 100 to 100,000 Cst or 1,000 to 80,000 Cst.

The reinforcing material may be impregnated within the matrix. In an implementation, the reinforcing material may be selected from among glass fiber, glass fiber cloth, glass fabric, non-woven glass cloth, glass mesh, glass beads, glass powder, glass flakes, silica particles, colloidal silica, or the like. The composite sheet may be prepared by impregnating components constituting the matrix within the reinforcing material, followed by crosslinking.

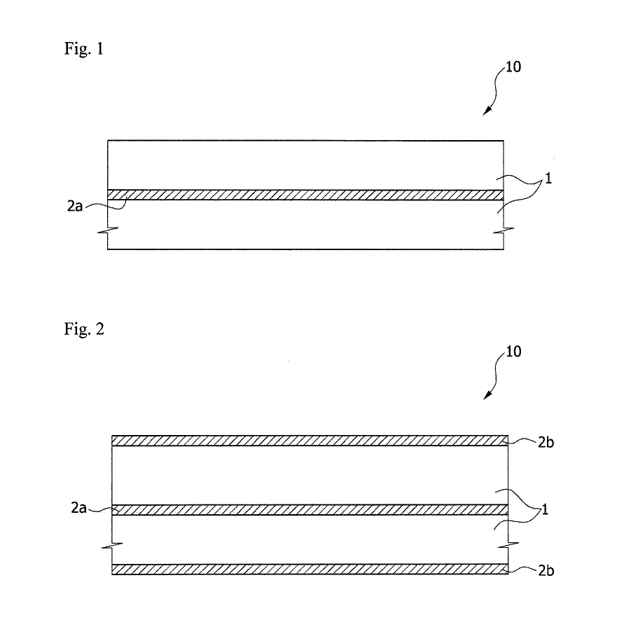

FIG. 1 illustrates a sectional view of a composite sheet 10 according to an embodiment. Referring to FIG. 1, when a reinforcing material 2a is of a sheet type (such as glass fiber cloth, glass fabric, non-woven glass cloth, glass mesh, or the like), the sheet type reinforcing material 2a may be impregnated into a matrix 1. Although the sheet type reinforcing material 2a is illustrated as constituting a single layer within the matrix 1 in FIG. 1, two or more layers of the sheet type reinforcing material 2a may be formed therein. For example, the reinforcing material may have a stack structure of two or more kinds of glass fiber cloth or a stack structure of glass fiber cloth and non-woven glass cloth. For example, in the ‘stack’ structure, two or more of the sheet type reinforcing materials may be stacked one above another in a contacting state or in a separated state via the matrix interposed therebetween.

In an implementation, when the reinforcing material 2a is of a fiber type or powder type (such as glass fiber, glass beads, glass powder, glass flakes, silica particles, or colloidal silica matrix), the reinforcing material 2a may be dispersed within the matrix. Herein, the term ‘disperse’ may include uniform dispersion and non-uniform dispersion.

In an implementation, the sheet type reinforcing material sheet and the powder type reinforcing material may be used together.

The reinforcing material 2a may be present in the composite sheet in an amount of 5 to 95 vol %, e.g., 35 to 75 vol %. Within this range, the composite sheet may exhibit excellent flexibility and rigidity, and may have a small coefficient of thermal expansion.

FIG. 2 illustrates a sectional view of a composite sheet 10 according to another embodiment. Referring to FIG. 2, the composite sheet 10 may include at least one coating layer 2b on at least one surface of a matrix 1. The coating layer may be formed on one or more (e.g., both, outer) surfaces of the matrix 1. The coating layer 2b may be formed on the surface of the matrix 1 by, e.g., physical vapor deposition, chemical vapor deposition, coating, sputtering, evaporation, ion plating, wet coating, organic-inorganic multilayer coating, or the like. The processes may be applied alone or in combination of two or more thereof.

The coating layer 2b may be formed of or may include, e.g., silicon nitride, silicon oxide, silicon carbide, aluminum nitride, aluminum oxide, ITO, IZO, metal, or the like. The materials may be used alone or in combination of two or more thereof. In an implementation, the coating layer 2b may be formed as a single layer or as multiple layers including two or more layers stacked one above another.

The coating layer 2b may be formed to have a thickness such that a ratio of the thickness of the coating layer 2b to a thickness of the matrix 1 is 1×10⁻³ to 5×10⁻¹, e.g., 1×10⁻³ to 5×10⁻². Within this range, it is possible to control removal of foreign surface matter and/or provide effective water vapor transmission rate.

The coating layer 2b may help optimize gas barrier properties, water vapor transmission resistance, mechanical properties, flatness, and/or adhesion between the matrix and the coating layer.

In an implementation, the matrix 1 may have a thickness T1 of 50 to 200 μm, e.g., 70 to 150 μm, and the coating layer 2b may have a thickness T2 of 1 to 300 nm, e.g., 10 to 150 nm. Within this range, it is possible to maximize water vapor transmission resistance while suppressing separation of an upper coating layer. In an implementation, the composite sheet 10 including the coating layer 2b may have a total thickness of 10 to 500 μm, e.g., 50 to 150 μm. Within this range, it is possible to minimize problems in a TFT process.

The composite sheets according to the embodiments may be applied to displays or optical devices, e.g., substrates for liquid crystal displays, substrates for color filters, substrates for organic electroluminescent (EL) displays, solar cell substrates, or the like.

When the composite sheet is applied to a substrate for a display device, the substrate may have a coefficient of thermal expansion of 20 ppm/° C. or less, e.g., 10 ppm/° C. or less.

According to the embodiments, the composite sheet may have excellent flexibility, transparency and heat resistance, and may exhibit high resistance to impact, stretching, bending, or the like. Further, the composite sheet may have a low coefficient of thermal expansion, low optical anisotropy, and low water vapor transmission rate while exhibiting excellent flatness and display quality. The substrate for a display device (including the composite sheet) may have a small size, may be slim, and may be lightweight, and thus may help reduce manufacturing cost.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

Details of components used in Examples and Comparative Examples are as follows.

(A) Matrix: Sylgard 184 (Dow Corning Co., Ltd.), which has a viscosity of 4,000 Cst and an elastic modulus of 2×10⁷ dyne/cm² at 25° C.

(B1) Reinforcing material: Glass cloth 3313 (Nittobo Co., Ltd.)

(B2) Coating layer: Silicon oxide and silicon nitride were alternately used.

### Example 1

With a reinforcing material (Glass cloth 3313, Nittobo Co., Ltd.) placed on a glass substrate (Carrier Glass), a matrix resin (Sylgard 184, Dow Corning Co., Ltd.) was applied to the reinforcing material. Then, a cover glass was placed on the matrix, and the glass cloth was impregnated into the matrix through lamination. The substrate or carrier glass was removed after heat curing.

### Example 2

Example 2 was the same as Example 1 except that the surface of the composite sheet was further subjected to alternate deposition of silicon oxide and silicon nitride through sputtering.

### Example 3

Trimethoxyphenylsilane (200 g), tetramethyldivinyldisiloxane (38.7 g), deionized water (65.5 g), toluene (256 g), and trifluoromethanesulfonate (1.7 g) were mixed in a three-neck round bottom flask equipped with a Dean-Stark trap and a thermometer. The mixture was heated at 60 to 65° C. for 2 hours. The mixture was refluxed, and water and methanol were removed via the Dean-Stark trap. When the reaction temperature reached 80° C. and water and methanol were completely removed, the mixture was cooled below 50° C. Calcium carbide (3.3 g) and water (about 1 g) were added to the mixture. The mixture was stirred for 2 hours at room temperature, and potassium hydroxide (0.17 g) was added to the mixture. Then, the mixture was refluxed, and water was removed via the Dean-Stark trap. When the reaction temperature reached 120° C. and water was completely removed, the mixture was cooled below 40° C., chlorodimethylvinylsilane (0.37 g) was added to the mixture, followed by mixing for 1 hour at room temperature. A solution of silicone resin having chemical formula of (PhSiO_{3/2})_{0.75}(ViMe₂SiO_{1/2})_{0.25} in toluene was obtained by filtering the mixture. The obtained silicone resin had a weight average molecular weight of about 1,700 g/mol, a number average molecular weight of about 14.40 g/mol, and a viscosity of 150,000 Cst, and contained about 1 mol % of a silicon-coupled hydroxy group.

The resin solution was mixed with 1,4-bis(dimethylsilyl)benzene such that a mole ratio of the silicon coupled hydrogen element to the silicon-coupled vinyl group (SiH/SiVi) became 1.1:1. Toluene was removed from the mixture by heating the mixture at 80° C. under a pressure of 5 mmHg (667 Pa). Then, a small amount of 1,4-bis(dimethylsilyl)benzene was added to the mixture to restore the mole ratio of SiH/SiVi to 1.1:1. In terms of the weight of the resin, a platinum catalyst (containing 1,000 ppm of platinum) was added in an amount of 0.5% w/w to the mixture. The catalyst was prepared by treating a platinum(0) complex of 1,1,3,3-tetramethyldisiloxane, in the presence of a large molar excess of 1,1,3,3-tetramethyldisiloxane, with triphenylphosphine to achieve a mole ratio of triphenylphosphine to platinum of about 4:1.

An impregnated sample was prepared by the same method as in Example 1 using this mixture as the matrix resin.

### Comparative Example 1

Comparative Example 1 was the same as Example 1 except that an acrylic resin (CK1002, Noru Paint Co., Ltd.) was used as the matrix and UV curing was performed using an initiator (Igacure 184).

TABLE 1

| | Ratio of | Coefficient | Water vapor |
|---|---|---|---|
| | elastic | of thermal | transmission |
| | moduli | expansion | rate |
| | (E1/E2) | (ppm/° C.) | g/m²-day |
| Example 1 | 3 × 10⁻⁵ | 5 | 20 |
| Example 2 | 3 × 10⁻⁵ | 5 | 0.05 |
| Example 3 | 1 × 10⁻⁴ | 10 | 10 |
| Comparative | 4 × 10⁻² | 21 | 15 |
| Example 1 | | | |

### Measurement of Mechanical Properties

(1) Elastic modulus: elastic modulus was measured at room temperature using an MTS Alliance RT/5 test frame equipped with a 100 N load cell. The test specimen was loaded into two pneumatic grips spaced apart by 25 mm and pulled at a crosshead speed of 1 mm/min. Load and displacement data were continuously collected. The steepest slope in the initial section of the load-displacement curve was taken as the Young's modulus. For each of the matrix and the reinforcing material, elastic modulus at 25° C. was measured. The ratio of the elastic moduli is shown in Table 1.

(2) Coefficient of thermal expansion: coefficient of thermal expansion was measured using a TMA instrument (Texas Instruments, Q40) according to ASTM E 831.

(3) Water vapor transmission rate: water vapor transmission rate was measured using a MOCON instrument according to ASTM F 1249. A prepared specimen was cut to a size of 30 mm×40 mm and fitted into a jig punctured at the center thereof for measurement. A vapor pressure at room temperature was treated as a relative humidity of 100%.

By way of summation and review, plastic substrates, e.g., polyester such as polyethylene terephthalate (PET) and polyethylene naphthalate (PEN), polycarbonate, polyethersulfone (PES), cyclic olefin resins, epoxy resins, and acrylic resins, may be used. However, plastic materials may have considerably high coefficients of thermal expansion and thus may cause bending of products or breaking of wires. Although polyimide resins may have a relatively low coefficient of thermal expansion, they may not be suited to a substrate material due to remarkably low transparency, high birefringence, and hygroscopic properties.

A transparent composite optical sheet may be prepared using ester group-containing alicyclic epoxy resins, bisphenol A epoxy resins, an acid anhydride curing agent, a catalyst, and glass fiber cloth. Another transparent composite optical sheet may be formed of ester group-containing alicyclic epoxy, epoxy resins having a dicyclopentadiene structure, an acid anhydride curing agent, and glass fiber cloth. Another transparent substrate may be formed of bisphenol A epoxy resins, bisphenol A novolac epoxy resins, an acid anhydride curing agent, and glass fiber cloth. However, such composite sheets may have a large difference in coefficient of thermal expansion between the fibers and the resin matrix, which may generate stress causing failure, and high optical anisotropy, which may reduce display performance.

The embodiments may provide a composite sheet composed of a material having a certain elastic modulus to thereby exhibit excellent flexibility and heat resistance and to have a low coefficient of thermal expansion so as to be suited to a substrate for a display device.

The embodiments may provide a composite sheet having excellent flexibility, transparency, and heat resistance, and exhibiting high resistance to impact, stretching, bending, and the like.

The embodiments may provide a composite sheet that has a low coefficient of thermal expansion and low optical anisotropy.

The embodiments may provide a substrate for a display device that includes the composite sheet, which may have a small size and is slim and lightweight, and enable a reduction in manufacturing cost.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composite sheet, comprising:
a matrix, and
a reinforcing material impregnated within the matrix,
wherein a ratio of an elastic modulus at 25° C. of the matrix to an elastic modulus at 25° C. of the reinforcing material is 1×10⁻² or less.

2. The composite sheet as claimed in claim 1, wherein the ratio of the elastic modulus at 25° C. of the matrix to the elastic modulus at 25° C. of the reinforcing material is in a range of 1×10⁻⁷ to 1×10⁻².

3. The composite sheet as claimed in claim 1, wherein the elastic modulus at 25° C. of the matrix is 1×10⁵ dyne/cm² to 1×10⁹ dyne/cm².

4. The composite sheet as claimed in claim 1, wherein the matrix includes at least one selected from the group of silicone rubber, styrene-butadiene rubber, butadiene rubber, isoprene rubber, chloroprene, neoprene rubber, ethylene-propylene-diene terpolymer, styrene-ethylene-butylene-styrene block copolymer, styrene-ethylene-propylene-styrene block copolymer, acrylonitrile-butadiene rubber, hydrogenated nitrile rubber, fluorinated rubber, plasticized polyvinyl chloride, and combinations thereof.

5. The composite sheet as claimed in claim 1, wherein the reinforcing material includes at least one selected from the group of glass fiber, glass fiber cloth, glass fabric, non-woven glass cloth, glass mesh, glass beads, glass powder, glass flakes, silica particles, colloidal silica, and combinations thereof.

6. The composite sheet as claimed in claim 5, wherein the reinforcing material includes glass fiber cloth, glass fabric, non-woven glass cloth, or combinations thereof.

7. The composite sheet as claimed in claim 5, wherein the reinforcing material is present in the composite sheet in an amount of 5 to 95 vol %.

8. The composite sheet as claimed in claim 1, further comprising a coating layer on at least one surface of the matrix, the coating layer including at least one selected from the group of silicon nitride, silicon oxide, silicon carbide, aluminum nitride, ITO, and IZO.

9. A substrate for a display device comprising the composite sheet of claim 1.

10. The substrate as claimed in claim 9, wherein the substrate has a coefficient of thermal expansion less than or equal to 20 ppm/° C.
